(19) United States
(12) Patent Application Publication
(10) Pub. No.: US 2024/0300343 A1
(43) Pub. Date: Sep. 12, 2024

(54) Power Supply and Distribution Networks

(71) Applicant: Capatech Limited, Kingston-Upton-Thames, Surrey (GB)

(72) Inventors: Charles Lucas-Clements, Kingston-Upton-Thames, Surrey (GB); Ashkan Daria Hajiloo, Kingston-Upton-Thames, Surrey (GB); Mansour Salehi Moghadam, Kingston-Upton-Thames, Surrey (GB); Gareth O'Brien, Kingston-Upton-Thames, Surrey (GB); Dominic Quennell, Kingston-Upton-Thames, Surrey (GB)

(21) Appl. No.: 18/568,438

(22) PCT Filed: Jun. 9, 2022
(86) PCT No.: PCT/EP2022/065760

§ 371 Date: Dec. 8, 2023

(30) Foreign Application Priority Data
Jun. 9, 2021 (EP) 21178610.8
Sep. 24, 2021 (EP) 21198991.8
Dec. 6, 2021 (EP) 21212633.8

(51) Int. Cl. B60L 53/122; H02J 50/10; H02J 50/40

(52) U.S. Cl. CPC B60L 53/122; H02J 50/10; H02J 50/40

(57) ABSTRACT

A power supply system comprises a first node connected to a second node via an electrically conducting cable, wherein the cable is conducting alternating current at high frequency (e.g. 100 Hz or higher, e.g. 20 KHz or higher) between the first and second nodes, and the electrically conducting cable is a capacitive cable. A power supply at the high frequency can be connected to the first node, or a power supply at 50 or 60 Hz can be connected to a converter outputting power at the high frequency with the converter output connected to the first node. A converter can be connected to the second node, or an electrical appliance operating using high frequency power can be connected to the second node. A related wireless electric vehicle charging system comprises (a) a power supply, optionally a power supply system of the invention. (b) an inverter connected to the power supply and adapted to output power at a high frequency. e.g. 1 kHz and above, and (c) a plurality of wireless charging stations, each comprising at least one transmitter, wherein the inverter is connected to each of the plurality of wireless charging stations using a capacitive cable.

### INTRODUCTION

The present invention relates to power supply and distribution networks in general, and to specific embodiments of the same. The invention applies also to export systems of onshore or offshore power generation units connected to distribution and transmission systems.

The present invention also relates in certain embodiments to wireless power transfer and its use in a system for charging electric vehicles. In particular, the invention relates to charging of electric vehicles in static systems, e.g. car parks, and in dynamic systems, e.g. roadways.

### BACKGROUND TO THE INVENTION

Some power distribution and supply applications require the use of higher frequencies to either reduce the overall system cost or reduce the weight and sizes of electrical machines such as transformers, motors and generators. A drawback of using higher frequency alternating currents is that the impedance of the electrical connections, typically cables, increases to a level such that either the transfer is inefficient, because of the additional losses, or it is impossible, because of the voltage drop resulting over longer connections.

Size and weight reduction is thus achieved in aviation electrical systems, where 400 Hz systems are used to charge on-board batteries and to power devices such as actuators, instrumentation, radars, etc. The power is delivered to the aircraft via either centralised systems with fixed installations transforming the ordinary grid frequency to 400 Hz and comprising frequency converters and ordinary cables, or mobile systems comprised of diesel generators, frequency converters and cables.

For similar reasons, maritime applications also use higher frequency systems, typically 400 Hz systems, to power on-board systems. The power is produced centrally and delivered throughout the ship at various voltage levels and 400 Hz either via ordinary cables or via converters/inverters placed near the 400 Hz apparatus.

Other applications of higher frequency alternating currents include space, computer power and radar systems.

An issue with higher frequency systems is, as mentioned, the voltage drop occurring along the cables. As the cable reactance increases with both frequency and length of the cable, for higher frequency systems the transfer of power is limited to short distances from the power sources. The use of mobile systems in the aviation applications and the use of multiple converters/inverters in the maritime applications are attempts to overcome this critical problem.

Another issue regards the higher losses occurring in the cable because of the higher equivalent resistance due to the so-called “skin effect”. The skin effect describes the concentration of the current towards the edge of the cable cross section. Such current concentration reduces the cross section effectively used for conduction and therefore increases the equivalent resistance and power losses along the cable. The skin effect is associated to the magnetic field generated by the current itself and therefore the cable inductive reactance. The magnitude of the skin effect increases with the frequency of the current passing through the cable.

Limitations to the cable length generate additional design and safety issues for aviation application. As the distance from the power source is limited, the cables of the networks cannot be easily buried, particularly for remote parking spots. Furthermore, the frequency converters must be located in the proximity of the load/appliance, typically in sub-optimal environmental conditions, which increase both safety and availability issues.

Development of a 20 kHz test bed is described in Button et al., 6 Aug. 1989, XP010089777, pp. 605-610, noting e.g. that the Gore cable thereof has “a higher capacitance compared to that of the Litz cable” thereof. In the context of the present invention, for which see below, this does not, however, relate to a capacitive cable that has a capacitive coupling within the conductor.

Background technical information is also known from Tsai et al., XP000127753, 1 Mar. 1990, pp. 239-253; Rahman et al., XP033921327, 1 Nov. 2020, pp. 135901364; JP 4536131; Rivera et al., 1 Feb. 2021, XP011862658 and WO 00/04621.

More specifically, an existing wireless electric vehicle charging system typically comprises a frequency converter, commonly known as a power converter or inverter, connected to a power supply, wherein the inverter is adapted to output power in the form of alternating current (AC) transmitted at a high frequency. The system also comprises a wireless charging station connected to the inverter using a conventional (i.e. conductive) cable. When charge from the inverter reaches the wireless charging station, a transmitter that forms a part of the wireless charging station generates a magnetic field around the wireless charging station. When an electric vehicle is then positioned in the proximity of the wireless charging station, the magnetic field induces an electric current in a receiver within the electric vehicle, wherein the receiver is connected to a battery of the electric vehicle and current from the receiver therein charges the battery. Accordingly, power is transferred wirelessly from the wireless electric vehicle charging system to the battery of the electric vehicle, therein charging the battery.

It is essential that the power output of the inverter is transmitted along the cable to the wireless charging station at a high frequency because this ensures that a greater level of power is transmitted to span the gap between the wireless charging station and the receiver of the electric vehicle. Wherein the electric vehicle is a car, this gap is typically 15 cm to 50 cm. The gap can be more or less in bespoke systems.

Existing wireless electric vehicle charging systems that operate in this manner are limited in terms of the number of wireless charging stations that can receive power from each inverter. This is because, as mentioned, power must be transmitted at a high frequency in wireless electric vehicle charging systems. When high frequency transmission is used, a very high impedance is generated in the conventional cable because the magnitudes of the skin effect and the inductive reactance in the cable increase with the frequency used. The result of this is that power losses and voltage drop increase along the length of the cable and thus the ability of the cable to transmit power decreases along its length. For this reason, the cable must be as short as is reasonably possible to ensure that the power reaching the wireless charging station is sufficient for the desired rate of charging of the electric vehicle. Accordingly, many existing wireless electric vehicle charging systems use a cable that is only 2 m to 3 m in length. Given that the different wireless charging stations installed at a site are usually spaced apart more than 2 m to 3 m from each other, it is not uncommon for each inverter to only be connected to 1 wireless charging station. This means that a different inverter has to be installed for each wireless charging station installed at a site.

There are several problems associated with the need to install multiple inverters at sites designed to enable wireless electric vehicle charging. Firstly, these wireless electric vehicle charging systems may be expensive to install at sites requiring many wireless charging stations due to the extensive infrastructure required. Secondly, having multiple inverters positioned at intervals around the site leaves these inverters vulnerable either to being driven into by an electric vehicle parking at a wireless charging station or to being vandalised. Additionally, inverters generate electric and magnetic fields, so present a risk to public safety if these are not adequately shielded.

Furthermore, in a comparative example described in more detail below, it has been demonstrated that connecting a plurality of wireless charging stations to a single inverter using a conventional cable results in significant power loss to the second and subsequent wireless charging stations and is unworkable.

A wireless electric vehicle charging system was established comprising a power supply connected to an inverter, wherein the inverter is connected in series to 4 wireless charging stations via a conventional cable. When this system was tested, it was found that power was not distributed evenly between each of the 4 wireless charging stations. Instead, the wireless charging station closest to the inverter receives the most power, the second wireless charging station receives less power than the first, the third receives even less than the second and the fourth receives the least power.

This uneven distribution of power between each of the plurality of wireless charging stations connected to the inverter creates an additional logistical problem. Electric vehicles requiring the most power need to use the charging points closest to the inverter or converter, whilst those requiring the least power should use the charging points furthest away from it. This requires careful planning to make sure all electric vehicles being charged by the wireless electric vehicle charging system are positioned at the most appropriate wireless charging stations.

It is also known that many electric vehicles cannot travel long distances when reliant on a single charge of their batteries. As a result, many electric vehicle users have to stop to charge their vehicles at least once during their journey. Accordingly, there remains a need to provide a method for charging moving electric vehicles so that the number of stops a user has to make on their journey to charge their electric vehicle is minimised. This has been proposed as a theoretical concept and is known as “dynamic charging” but has not previously been implemented successfully on a fully commercial basis.

In the art, US 2015/177302 discloses wireless charging set-ups, with one or more of the problems described, and US 2018/254643 relates to plug-in recharging, i.e. not wireless at all. In more detail, US 2015/177302 relates to systems, methods and apparatus for assessing electromagnetic exposure from a wireless electric vehicle charging system, and discloses that the power may be transferred at a low frequency, namely 10-60 Hz. In the context of the present invention, for which see below, this teaches away from high frequency power systems.

Also in the art, background technical information may be found in US 2017/136890; US 2017/136881; US 2016/031330; WO 2021/050642; WO 2010/131983; Pevere et al., 2014 IEEE International Electric Vehicle Conference, 17 Dec. 2014, pp 1-7, XP032744152 and Feng et al, IEEE Transactions on Transportation Electrification, vol. 6, no. 3, 28 Jul. 2020, pp 886-919, XP011809983.

Accordingly, there is a need for alternative power distribution and supply systems that address one or more of the problems identified above, and preferably provide improvements thereto.

Accordingly, there also remains a need for a wireless electric vehicle charging system wherein a plurality of wireless charging stations may be connected to a single inverter, without a need for the wireless charging stations to be positioned typically within 2 m to 3 m of the inverter, and preferably wherein all of the wireless charging stations connected to the inverter may provide equal amounts of power to the electric vehicles being charged.

It would also be desirable to provide a wireless electric vehicle charging system that may be adapted to provide power to moving electric vehicles so that users of these electric vehicles would be required to stop less often on their journey.

### SUMMARY OF INVENTION

The invention provides a power supply system, comprising a first node connected to a second node via an electrically conducting cable, wherein
the cable is conducting alternating current at high frequency between the first and second nodes, and
the electrically conducting cable is a capacitive cable.

The invention also provides a method of supplying power between 2 nodes in a power supply system, comprising
providing a first node connected to a second node via an electrically conducting cable, and
providing power to the first node, wherein
   the power comprises alternating current at high frequency, and
   the electrically conducting cable is a capacitive cable.

In the invention a node can be a cable end, optionally connected to a further length of cable. A node is suitably an electrically conducting input or output at a cable end. A load may be drawn from the second node. Capacitive cables for use in the invention may comprise multiple take-offs each of which may be connected to a distinct load, sometimes referred to as ‘pig-tails’ which may not be terminated in the manner of a cable end; another suitable node is a take-off from a capacitive cable.

A wireless electric vehicle charging system of certain embodiments of the invention accordingly comprises:
a power supply,
an inverter connected to the power supply and adapted to output power at a high frequency, and
a plurality of wireless charging stations, each comprising at least one transmitter,
   wherein the inverter is connected to each of the plurality of wireless charging stations using a capacitive cable.

Similarly, the invention provides a method of charging an electric vehicle comprising positioning the electric vehicle in the proximity of a wireless charging station that is part of the defined wireless electric vehicle charging system. In the case of dynamic charging systems, this typically involves moving the electric vehicle into sufficiently close proximity to, i.e. into the charging range of, the wireless charging station, e.g. over, under or beside the wireless charging station.

For installation of such a system, a kit for a wireless electric vehicle charging system of the invention comprises:
an inverter for connection to a power supply and adapted to output power at a high frequency,
a plurality of wireless charging stations, each comprising at least one transmitter, and
one or more capacitive cables, for connecting the inverter to each of the plurality of wireless charging stations,
   wherein the inverter, the wireless charging stations and the capacitive cable are as defined herein.

### Details of the Invention

A power supply system of the invention hence comprises a first node connected to a second node via an electrically conducting cable, wherein
the cable is capable of conducting alternating current (AC) at high frequency between the first and second nodes, and
the electrically conducting cable is a capacitive cable.

In use, the cable conducts AC power between the nodes, suitably according to one or more or a combination of the embodiments described in more detail below. The second node may conduct electrical power to a further cable or to an appliance that uses electrical power (a load). The first node can be an electrically conductive coupling to a further cable or to a power input or a source of power.

In a first series of embodiments of the invention, the second node is connected to one or more electrical appliances that convert the power into heat, light and/or mechanical work, such as motors, actuators, light bulbs, heaters, air conditioning units, instruments, machines etc that operate using high frequency power. Preferably, the second node is connected to a plurality of electrical appliances.

These embodiments include, for example, distribution of high frequency power at airports and seaports. An advantage is that power from the second node can be divided between multiple high frequency users.

These embodiments include vehicles with internal power systems that operate using high frequency power. In a specific embodiment, an airplane comprises a power supply system of the invention. In a further specific embodiment, a ship comprises a power supply system of the invention.

In a second series of embodiments of the invention, the second node is connected to an inverter that reduces the frequency down to 50 or 60 Hz. This low or regular (or ‘normal’) frequency power output can then in turn be connected to one or more electrical appliances that convert the power into heat, light and/or mechanical work, such as motors, actuators, light bulbs, heaters, instruments, machines etc that operate using low frequency power; again, the output is preferably connected to a plurality of such appliances. An advantage of this arrangement is that high frequency power can be transmitted over long distances and then be converted back to low frequency for use using regular or conventional frequency appliances.

In a third series of embodiments of the invention, a power supply at 50 or 60 Hz is connected to the first node by an inverter which increases the frequency of the power input to the first node to high frequency. An advantage of this arrangement is that power can be generated at regular frequency and can then be transmitted over long distances at high frequency.

In a fourth series of embodiments of the invention, a power supply is connected to the first node and supplies it with power generated at a high frequency by a generator or battery. An advantage of this arrangement is that power can be generated at high frequency and then transported over long distances at this same frequency, rather than being generated at low frequency and then needing to be converted to a higher frequency for long-distance transmission.

Advantages of the invention are also described elsewhere herein, and include reduced power losses and voltage-drop over cable length/distance. Suitably, the capacitive cable is of significant length, enough for these benefits to be realised and to be relevant to power system design. Benefits of the invention are realised over shorter cable lengths the higher the frequency of the alternating current. For example, the capacitive cables are generally of length 1 m or greater, or 5 m or greater, generally 25 m or greater, 100 m or greater, especially 200 m or greater and 500 m or greater. Uses of the invention include conducting very high frequency power, e.g. 10 kHz or greater, for which there are advantages even over very short cable lengths, such as 1 m or greater or 5 m or greater. Uses of the invention extend to embodiments comprising cables that are in effect transmission lines that are capacitive cables, these being of length 1 km or greater, preferably 5 km or greater or even 10 km or greater. For use in power grids, cables may be 100 km or greater or longer still, including many hundreds of km in length.

In a first specific embodiment of the invention, described in more optional detail in an example below, an airport comprises a power supply system according to the invention.

In a second specific embodiment of the invention, a seaport comprises a power supply system according to the invention, described in more detail in an example below.

In a third specific embodiment of the invention, a power supply network comprises a power supply system according to the invention. The network may comprise one or more cables installed underground on land or at sea, or along the seabed. The network may comprise one or more cables installed along a plurality of pylons carrying the cable, described further in an example below. Uses of this embodiment of the invention extend to connections of one or more cables, preferably a plurality of cables, to individual pylons, preferably with each pylon having a plurality of cables connecting to it, where the cables are capacitive cables. This third embodiment enables a network spanning distances of 100 km or longer to transmit power using the power supply system according to the invention.

Also provided by the invention are methods of supplying power between 2 nodes in a power supply system, comprising
providing a first node connected to a second node via an electrically conducting cable, and
providing power to the first node, wherein
   the power comprises alternating current at high frequency, and
   the electrically conducting cable is a capacitive cable.

In typical use, a power source is connected to the first node and a load is connected to the second node. Such connections can be direct or indirect, e.g. via intervening cabling. Optional and preferred features and embodiments discussed elsewhere herein in relation to the power supplies of the invention apply also to the methods of supplying power of the invention. Hence, for example, the methods may comprise supplying power to an inverter at 50 or 60 Hz, and using the inverter to increase the frequency to high frequency, the high frequency power being supplied to the first node, and/or the methods may comprise using an inverter to decrease the frequency to 50 or 60 Hz, the inverter being connected to an output of the second node.

As described elsewhere in more detail, an advantage of the present invention is that there is low power loss and voltage drop along the cable when high frequency power is used. Unlike conventional cables, wherein, at high frequency, both voltage and power can decrease substantially along a short length of the cable, capacitive cables can transfer high frequency power along their lengths with little loss.

Examples of these advantages are relevant to further specific embodiments of the invention that concern wireless charging of vehicles. According to the invention, there is thus provided a wireless electric vehicle charging system, comprising:
a power supply,
an inverter connected to the power supply and adapted to output power at a high frequency, and
a plurality of wireless charging stations, each comprising at least one transmitter,
   wherein the inverter is connected to each of the plurality of wireless charging stations using one or more capacitive cables. The one or more cable connections may be annular or radial connections via or to one or more cables.

Thus, an inverter adapted to output power, typically AC, at a high frequency is connected using a capacitive cable to a plurality of wireless charging stations, each comprising at least one transmitter.

As described elsewhere in more detail, an advantage of the present invention is that there is low power loss and voltage drop along the cable, enabling use of a single inverter with many transmitters, or extending the range of the system, simplifying system design and reducing cost.

Certain installations, e.g. higher power ones, may comprise one or two transmitters per inverter. Greater cost savings are achieved with a higher ratio of transmitters to inverters. Typically, the inverter is connected to at least 5 wireless charging stations, preferably, to at least 10 wireless charging stations, and more preferably to at least 30 wireless charging stations. According to other system parameters, a higher number may be connected. Systems may also comprise a plurality of inverters connected in turn to respective sets of wireless charging stations.

Using a conventional cable, the wireless charging stations must generally be positioned no more than 2 m to 3 m away from the inverter, otherwise the transmission of power along the length of the cable would be too inefficient for a sufficient rate of charging to be provided. A further advantage of the present invention is that, for the first time, the wireless charging stations may be distanced from the inverter, e.g. positioned more than 2 m away from the inverter. In one installation of the invention under development charging stations are approximately 25 m or more from the inverter. This means that the wireless charging stations may be spaced apart from each other without the need for additional inverters to be installed as part of the wireless electric vehicle charging system.

In certain embodiments of the invention, the wireless charging stations are spaced apart at least 5 m from each other. In other embodiments of the invention, the wireless charging stations are spaced apart at least 10 m from each other. The system also provides roadways, e.g. modified existing roadways or new roadways, for charging moving vehicles, in which the wireless charging stations may be spaced still further apart—this is now possible according to the invention with notably reduced power loss.

In certain embodiments of the invention, the power output of the inverter is polyphasic. In such embodiments, power from different phases may be supplied to different wireless charging stations—e.g. a 3-phase supply with each phase connected to a single wireless charging station.

In other embodiments, the power output of the inverter is polyphasic and power from each phase is supplied to a plurality of wireless charging stations—e.g. a 3-phase supply with each phase connected to at least 2 wireless charging stations.

Charging of domestic cars in car parks is one specific embodiment of the invention. In certain embodiments of the invention, more generally, the wireless electric vehicle charging system may be used for charging one or more stationary electric vehicles. These embodiments of the invention are typically used for charging electric vehicles in a vehicle park, such as a car park or a coach park or a lorry park or similar. Embodiments of the invention may be used to charge electrically-operated ships, e.g. with a charging unit at the dock or port (and a receiver on the ship). The invention is also usefully employed for charging of buses on roadways or at a bus-stop, fork-lift trucks in warehouses, tugs for aircraft at airports, baggage carts at airports, commercial vehicles in general, haulage trucks in mines, carts and trucks for moving containers in container ports and drones; and is especially employed for a car, a light commercial vehicle, a bus or a haulage truck.

In other embodiments of the invention, the wireless electric vehicle charging system may be used for charging one or more moving electric vehicles. These embodiments of the invention are typically used for charging electric vehicles travelling on a roadway. The roadway may comprise a surface over which wheeled vehicles travel and can pass over or beside successive wireless charging stations and their respective transmitters one-by-one. These may be on a road such as a highway or motorway. The roadway may comprise lanes for the vehicles, with transmitters spaced apart along the lane. The roadway may comprise rails with transmitters spaced apart along the roadway and between the rails. In all cases the principle is the same: a vehicle passes close to, e.g. over or beside or beneath, the transmitters of successive wireless charging stations and receives sufficient power in that time, despite being in motion, for one or more batteries in the vehicle to be partially charged.

In embodiments of the invention wherein the wireless electric vehicle charging system is used for charging electric vehicles travelling on a roadway, the wireless electric vehicle charging system is integrated into the roadway. These systems comprise multiple charging units connected to each inverter. The charging units may be fairly close to each other, e.g. spaced apart 20 cm or more or 50 cm or more. In other embodiments, the wireless charging stations are spaced further apart, e.g. at least 25 m from each other. Alternatively, the wireless charging stations may be spaced apart at least 50 m from each other. The wireless charging stations may be spaced apart at least 100 m from each other. Suitably the system is arranged such that the vehicle receives enough power from its interaction with a given charging station to get to the next charging station, preferably more than enough. Travel along the roadway can then be continuous for long distances, beyond the single-charge range of the batteries, without any need to stop for recharging.

In further embodiments of the invention wherein the wireless electric vehicle charging system is used for charging electric vehicles travelling at low speed on a roadway, the wireless electric vehicle charging system is again suitably integrated into the roadway. In such embodiments of the invention, the wireless charging stations are spaced apart but fairly close to each other, e.g. at least 2 m from each other and up to 10 m apart. Alternatively, the wireless charging stations may be spaced apart at least 3 m and up to 10 m apart or up to 5 m from each other. The wireless charging stations may be spaced apart so the vehicles close to each other are charged at the same time. Exemplary such low speed or close distance charging scenarios include charging vehicles temporarily stopped at traffic lights, haulage trucks queuing along a roadway, vehicles queuing along a roadway for shops or for food outlets and taxis waiting for business at a taxi rank.

Hence, normally, wherein the wireless electric vehicle charging system is used for charging moving electric vehicles, the wireless electric vehicle charging system is adapted for vehicles to drive over the wireless charging stations one after the other.

Installations of a wireless electric vehicle charging system of the invention can be designed with various redundant features. In certain embodiments of the invention, and to this end, the wireless electric vehicle charging system may be provided as two or more distinct sub-systems. In such embodiments, each of the sub-systems has:
an inverter connected to a power supply and adapted to output power at a high frequency, and
a plurality of wireless charging stations, each comprising at least one transmitter,
   wherein the inverter is connected to each of the plurality of wireless charging stations using a capacitive cable, and wherein the inverters of the two or more sub-systems are connected in parallel to the power supply, and wherein the capacitive cable in each sub-system is connected to the capacitive cable in the other sub-system (or in one of the other sub-systems if more than one), and wherein each sub-system acts as a backup system for another sub-system in the event that one of the inverters ceases to function—for example the inverter may fail or be taken out of service for maintenance or another reason. Thus, for example, one sub-system can provide redundancy for a plurality of others, giving redundancy of less than 100%.

The respective sub-systems are in this way connected in parallel and can cope with a failure in one parallel arm/sub-system while retaining functionality across all wireless charging stations.

In embodiments of the invention comprising two or more sub-systems, the power output of the inverter may be polyphasic. In such embodiments, each phase of the capacitive cable in each sub-system is connected to the same phase of the capacitive cable in the other sub-system (or one of the other sub-systems) and each sub-system acts as a backup system for the other sub-system in the event that one of the inverters fails. This ensures that, should one of the two inverters become damaged or cease to function for any other reason, or also if an inverter is taken out of service e.g. for maintenance, all of the wireless charging stations will remain operational (e.g. until a repair may be performed or the inverter otherwise comes back into service) because the second inverter will provide power to the first sub-system, although the wireless charging stations of both sub-systems may operate at a lower power level than normal during this time period (depending upon load across the system, e.g. number of vehicles trying to charge at any given time).

The power supply of the invention may provide power of any amount according to the available mains or other supply. However, it is preferred that the power supply provides 20 kW of power or more, or 50 kW of power or more for a system able to charge a reasonable number of vehicles simultaneously. In use of the invention, higher powers are envisaged; the power supply may provide 100 kW of power or more or power in the megawatt range.

The invention also provides a method of charging an electric vehicle, comprising positioning the electric vehicle in the proximity of a wireless charging station that is part of a wireless electric vehicle charging system of the invention. For dynamic charging the method may comprise moving the electric vehicle over or beside or beneath a wireless charging station that is part of a wireless electric vehicle charging system of the invention.

The invention still further provides a kit for an electric vehicle charging system of the invention and wherein the kit comprises
an inverter for connection to a power supply and adapted to output power at a high frequency,
a plurality of wireless charging stations, each comprising at least one transmitter, and
one or more capacitive cables, for connecting the inverter to each of the plurality of wireless charging stations,
   wherein the inverter, the wireless charging stations and the capacitive cable are as defined herein in relation to the system, and optional and preferred features thereof.

Still further provided by the invention is a vehicle park or roadway comprising a system of the invention as herein described. Also further provided by the invention is a method of modifying a vehicle park or roadway or providing a vehicle park or roadway, comprising providing the vehicle park or roadway with a system of the invention as herein described.

Herein, an “inverter” is an electronic device that converts an input current into an output alternating current, wherein the frequency of the output alternating current is at a specified nominal value. A “converter” may include an inverter, hence references to one may include reference to the other herein, and this is believed clear in context. A “wireless charging station” is an electronic device capable of providing power to an electric vehicle without needing to be galvanically connected to any part of the electric vehicle. A “capacitive cable” is any cable that has a capacitive coupling within the conductor/conductive elements—as defined elsewhere herein.

Capacitive cables exhibit a much lower loss of power and in particular voltage drop along their lengths when the power is transmitted at a high frequency than conventional cables. This is due to the fact that capacitive cables have a much lower reactance than conventional cables. Accordingly, using a capacitive cable instead of a conventional cable to connect an inverter to a wireless charging station, wherein both the inverter and the wireless charging station are part of a wireless electric vehicle charging system, allows the wireless charging station to be positioned more than 2 m to 3 m away from the inverter. One advantage lies in distancing the power source from the inverter. Another advantage lies in the option to have many charging stations connected to each inverter. Accordingly, a plurality of wireless charging stations may each be connected to a single inverter because the length of the cable is not limited by a loss of power, unlike when a conventional cable is used. This reduces the number of inverters that need to be installed at a given site for a given number of wireless charging stations, increasing the efficiency of the system and reducing the associated cost.

The inverter may be shielded to reduce health risks to people in the proximity of the inverter caused by electric and magnetic fields generated by the inverter. As fewer inverters are provided for the same number of wireless charging stations, compared to using a conventional cable, less shielding is needed, which further reduces the installation cost, and the public health risks posed by electric and magnetic fields are reduced.

The inverter may be positioned several metres away from the wireless charging stations it is connected to, as well as several metres away from the roadway and several metres away from vehicles moving on the roadway. This reduces the risk of an electric vehicle being driven into the inverter. Additionally, the fact that fewer inverters are required than in existing wireless electric vehicle charging systems further reduces the risk of these being driven into.

A further advantage of positioning the inverter several metres away from the wireless charging stations it is connected to is that the inverter may be positioned out of view of users of the site at which the wireless electric vehicle charging system is installed, which reduces the risk of the inverter being vandalised or tampered with.

By positioning the inverter several metres away from, i.e. many more than 2 m to 3 m away from, the wireless charging stations to which it is connected, the inverter may be positioned so that it is easily accessible to maintenance workers. For example, in embodiments of the invention wherein the wireless charging stations are positioned along the length of a roadway, the inverter may be provided adjacent to the roadway, rather than on or under the roadway. This ensures that the roadway does not have to be closed to allow maintenance workers to access the site.

Additionally, because capacitance is distributed along the entire length of a capacitive cable, each of the wireless charging stations connected to the inverter may receive a similar proportion of the power rather than those closest to the inverter receiving the most and those furthest away from the inverter receiving the least. Therefore, no planning is needed to determine which wireless charging station an electric vehicle should use.

If wireless charging stations are distributed along the length of a roadway, wherein a “roadway” is defined as “a surface over which wheeled vehicles travel”, a small amount of power would be transferred to the electric vehicle every time it drives over or beside or beneath a wireless charging station, resulting in the driver having to stop less often to charge the vehicle. This means that commercially viable dynamic charging has become feasible for the first time and also allows the use of electric vehicles with smaller batteries than those of existing electric vehicles, which results in environmental benefits.

A further advantage of the invention is that the wireless electric vehicle charging system may be easily upgraded in the event that demand for wireless electric vehicle charging increases. In such circumstances, it may be necessary to provide a greater power output from each wireless charging station, which requires a greater power input. This would require the inverter to be upgraded. In existing systems, this would be both expensive and time-consuming as multiple inverters would have to be upgraded at a particular site. However, the invention provides a wireless electric vehicle charging system wherein only one inverter would need to be upgraded. Accordingly, the invention provides a system that may be easily upgraded as demand for wireless electric vehicle charging increases.

The invention is intended for use with any type of electric vehicle fitted with a receiver capable of receiving power wirelessly from a transmitter. However, in preferred embodiments of the invention, the wireless electric vehicle charging system is used to charge an electric car, an electric commercial vehicle such as a van or a taxi, an electric bus or an electric haulage truck.

Embodiments of the invention are defined as using or comprising a capacitive cable. This term does not refer to cable capacitance properties of a conventional conductor such as a conventional power transmission line. It does not refer to capacitance between two isolated conductors in a conventional power transmission line. It refers instead to a cable that is part of a capacitive transmission system, and which is represented in a circuit diagram by a capacitor. The capacitive cable for use in the invention may be any capacitive cable that has a capacitive coupling within the conductor. Examples are described e.g. in WO 2010/026380, WO 2019/234449, WO 2021/094783, WO 2021/094782 and WO 2020/120932.

In general, especially in the UK, when the power output of the inverter is polyphasic, the inverter is a 3-phase inverter and the capacitive cable is a 3-phase capacitive cable or three single phase capacitive cables. As will be appreciated, a three-phase cable is suitably three cores in one cable or three single cables running one phase each.

An advantage of the present invention is that it can be used to provide power at a high frequency, in accordance with industry standards, though experiencing low voltage drop, consequently resulting in increased power transfer capability. In the field, the term “high frequency” is believed to be understood by the skilled person.

The invention relates to the application of capacitive cables to higher frequency networks, wherein by high frequency it is intended current frequencies higher than the nominal frequency of ordinary distribution or transmission power grids, which is 50 Hz in European countries, China or Australia and 60 Hz in the Americas, Caribbean, Korea and other countries.

For the present invention, to avoid any doubt, reference to “high frequency” in relation to the power output from the inverter is suitably taken to mean a frequency of at least 100 Hz, suitably at least 200 Hz, preferably at least 350 Hz; in certain embodiments described in more detail below high frequency refers to frequencies of about 400 Hz or at least about 400 Hz or at least 1 kHz, noting that the frequency of domestic AC power is about 50 Hz in the UK and 60 Hz in the US. In further embodiments of the invention, the power output of the inverter will have a frequency of at least 10 kHz. In some preferred embodiments, the power output of the inverter will have a frequency of at least 20 kHz. The power output of the inverter may also have a frequency of at least 50 kHz. At present in the UK and the USA, power supply standards approve high frequency power supplies at about 20 kHz and at about 80-85 kHz—these two frequency values hence represent specific embodiments of the invention, especially for UK use and in countries with similar approved standards. The invention can also operate at still higher frequencies. We note also that reference to a specific frequency corresponds to the standard reference to power frequency in the industry, i.e. using a single number though there may be allowance for variation, for example +/−1 Hz at 50 Hz or 60 Hz, +/−10 Hz at 400 Hz or 1 kHz and similar, though in general frequency variation is minimal.

An aspect of the invention relates exclusively to aircraft and/or airport power supply systems and to method of supplying power between 2 nodes in an aircraft and/or an airport power supply system. In this aspect, the power frequency is 400 Hz. In this specific context there is some variation acceptable within the frequency, suitably +/−10 Hz and preferably +/−2 Hz. The power voltage is not specific to this aspect though aircraft and/or airport power supply systems may use a voltage of 115V+/−3V and be capable of supplying 50 kVA or greater, 80 kVA or greater or 120 kVA or greater.

Other aspects of the invention may therefore exclude this above aspect. Other aspects of the invention may provide (i) non-aircraft and non-airport power supply systems and methods of supplying power and/or (ii) power supply systems and methods of supplying power wherein the power frequency is other than at 400 Hz (allowing for the stated variation, hence up to 390 Hz and above 410 Hz).

Other specific aspects of the invention relate exclusively to
(i) spacecraft and spaceport;
(ii) submarine and submarine port;
(iii) military vehicle, military equipment and military base; and
(iv) hand tool and hand tool parts and accessories
   power supply systems and methods of supplying power.

### EXAMPLES

The invention is now illustrated in the following examples, with reference to the accompanying drawings, in which:

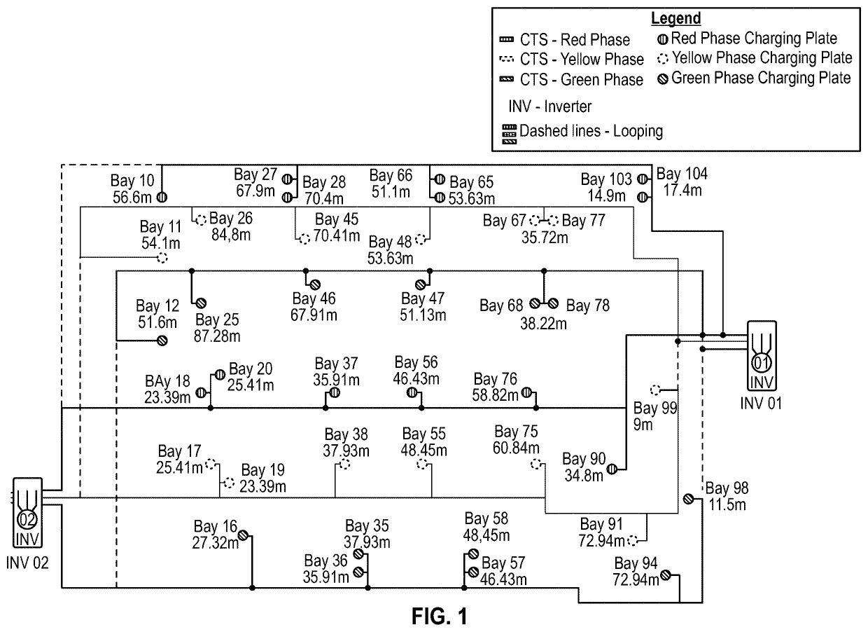

FIG. 1 shows a single line diagram (SLD) version of a car park laid out showing two sub-systems of the present invention;

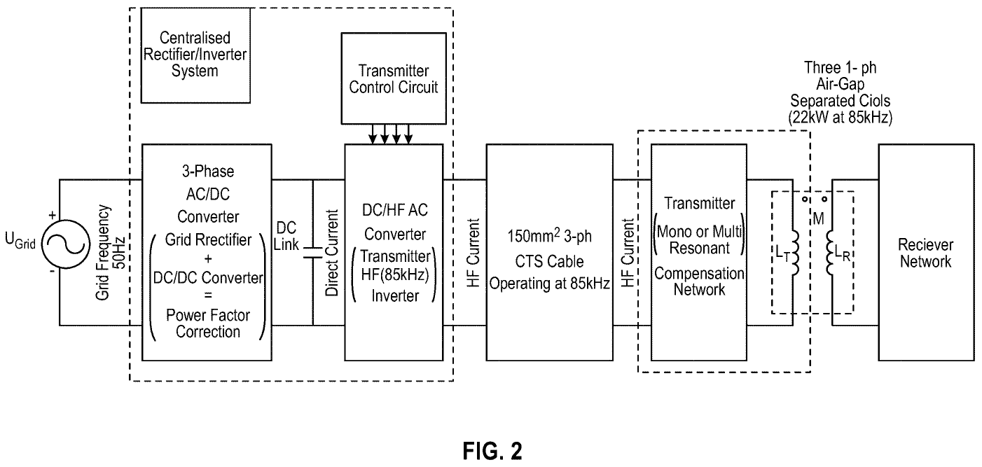

FIG. 2 shows a block-diagram of the key components of the invention from the power source to the load;

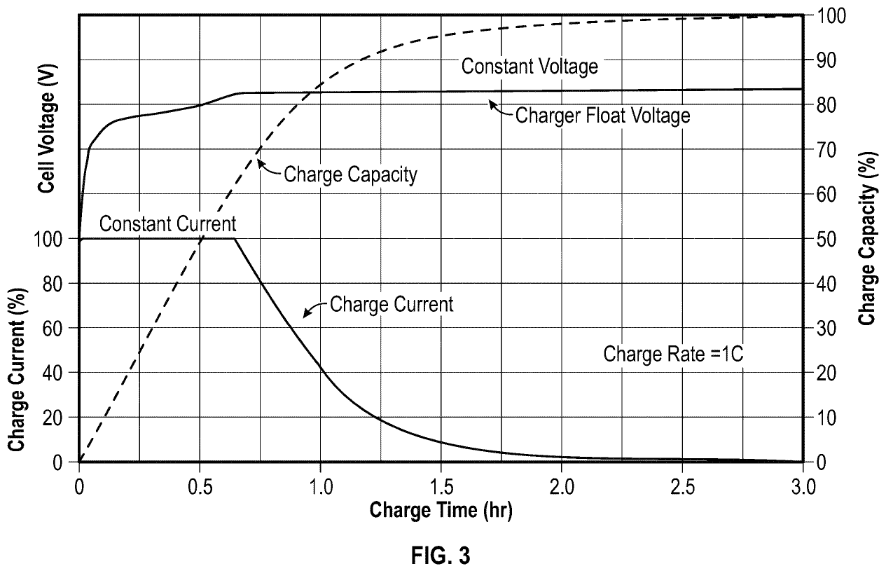

FIG. 3 shows the charging current/voltage profiles of electric vehicle batteries; and

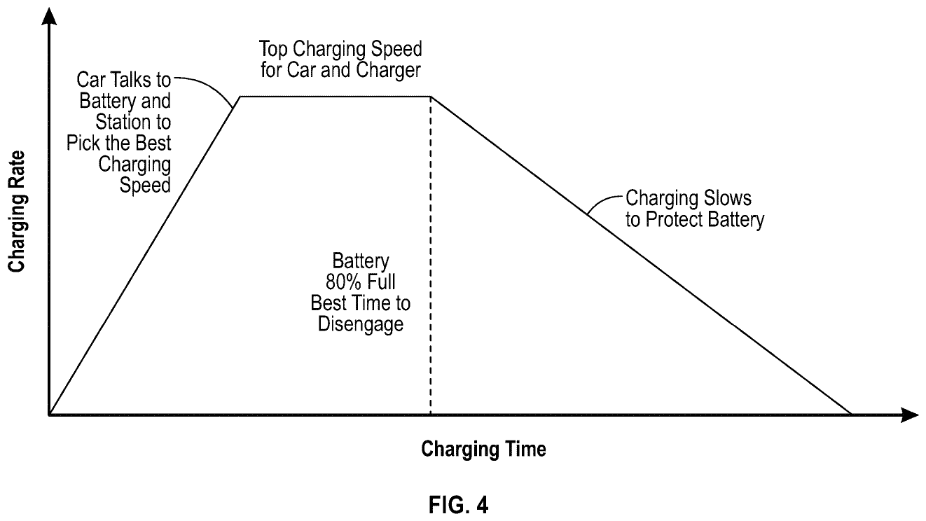

FIG. 4 shows the change in charging rate of a battery of an electric vehicle over time, according to the invention.

### EXAMPLE 1—ELECTRIC VEHICLE CHARGING SYSTEM

A static wireless electric vehicle charging system for a car park includes 39 wireless charging stations, each comprising a single transmitter and being integrated into a car parking space to enable an electric vehicle to park over the transmitter.

This charging system comprises two separate sub-systems, each being supplied by a 3-phase inverter with an output power of 150 kW, giving a total of 300 kW of input power. In each sub-system, a 3-phase capacitive cable is connected to the output of the 3-phase inverter. Each inverter acts as a backup for the other to ensure that, in the event that one inverter becomes damaged, all transmitters remain operational until a repair may be performed, although these transmitters will operate at a lower power level than the maximum during this time period.

FIG. 1 shows a single line diagram (SLD) version of a car park laid out showing two sub-systems. From inverter 1 (INV 01), the length of each of the phases of the capacitive cable is approximately 122.3 m. For the sub-system comprising inverter 2 (INV 02), the length of each of the phases of the capacitive cable is 98 m. The cross-section of each of the phases of the capacitive cable is assumed to be 150 mm² and the resultant aggregate cable length incorporated in the full system is at least 660.3 m. The different phases of the capacitive cable and the transmitters associated with these are distinguished by the green, yellow and red phase colour assignment. In addition, FIG. 1 displays the distance of each transmitter from its respective inverter.

The 39 wireless charging stations are separated into 3 groups with respect to each of the 3 phases of the capacitive cable. In other words, a total of 13 transmitters are powered and distributed along the length of each phase of the capacitive cable. The 3-phase capacitive cables are directly linked from the 3-phase inverter to the single-phase transmitter and each phase operates at a frequency of 85 kHz. Owing to the 3-phase infrastructure, a return/neutral cable is not needed. FIG. 2 provides a block-diagram of the key components from source to load, wherein the source is an inverter and the load is an electric vehicle.

Additionally, to create a balanced load system, a 3-phase loop configuration is used wherein the end length of each phase of the capacitive cable in each sub-system is connected to the same phase of the capacitive cable in the other sub-system, but at a length close to its inverter, as illustrated in FIG. 1. This also acts as the backup system in the event that one of the inverters fails.

Each of the transmitters is single-phase and is powered by one of the phases of the capacitive cable but a transmitter from one phase may establish a 3-phase connection with the transmitters in the other phases, as shown in the dotted line in FIG. 1.

A 3-phase high frequency switch is installed in the system to transition between the loop configuration and the linear configuration, as illustrated in FIG. 1.

The wireless electric vehicle charging system consists of 39 transmitters with each transmitter having a charging level rated at up to 22 kW. Two 150 kW inverters supply power to the capacitive cable and, thus, the transmitters, i.e. a total of 300 kW of output power of the two inverters. The set-up is such that when 39 wireless charging stations are active/occupied by electric vehicles at the same time, each transmitter is limited to charging at 7.7 kW, even if the vehicles have a higher charging capacity, i.e. 11 kW or 22 kW. If it is requested to increase the transmitter output power to 11 kW while all wireless charging stations are occupied, approximately 26 of the wireless charging stations will be active while the other 13 bays remain dormant to keep within the 300 kW input power limit. Similarly, using the transmitters at their full power rating of 22 kW will support 14 wireless charging stations while 25 remain inactive.

The correlation between the active and inactive units may change, depending on the state of the battery charge and the urgency with which a user wishes to leave the wireless charging station. Some vehicles may be charged faster because these need to leave the wireless charging station after a short period of time, conversely keeping certain vehicles in a charging state for a longer duration of time but at a lower charging level to provide leverage for other wireless charging stations.

Furthermore, the rate of charging may alter after a certain time interval, depending on the energised capacity of the electric vehicle battery. In other words, fast charging occurs when the battery is below a certain charge and once a designated threshold is reached, the battery may continue to be charged at a lower charging level, i.e. slow charging. This shift in intelligent power delivery provides additional wireless charging stations to either become active or increase their charging level depending on the status of the electric vehicle battery and the users' demand.

This typical power profile shift to the electrical charging of electric vehicle (lithium ion) batteries is somewhat similar to a capacitor, as shown in FIG. 3, which illustrates the charging current/voltage profile of these batteries.

From a starting point of a depleted battery, the charging rate is initially high, i.e. voltage rises at constant current and the battery regains much of its charge within a short period of time. Once the battery charge reaches a certain threshold of 80%, both the current and the charging rate decrease.

Furthermore, the slower charging rate after the 80% mark helps to prolong the life of the electric vehicle battery, as seen in FIG. 4.

When all 39 wireless charging stations are occupied by 22 kW rated electric vehicles, and based on control element inputs such as time and priority, 14 out of the 39 electric vehicles will be charged at a 22 kW rating whilst the other occupied bays remain inactive. After the 14 electric vehicles reach 80% of their full capacity, their continued charging process is postponed and the next 14 electric vehicles, dormant during the first phase, may begin charging. When these reach the 80% mark, the process may be repeated for the remaining 11 electric vehicles. Once all electric vehicles have reached the 80% charged capacity, these may be charged at a lower rate (longer duration) of 7.7 kW simultaneously.

### EXAMPLE 2—FIXED INSTALLATION IN THE AVIATION INDUSTRY

Power is supplied to an airport terminal at a frequency of 50 Hz via a conventional cable. The conventional cable is connected, at the airport terminal, to a centralised inverter that then converts the frequency of the power it receives to 400 Hz. The power having a frequency of 400 Hz is then transmitted to a plurality of power outlets, each of which is installed at a different gate of the airport terminal, via capacitive cables. Each power outlet is connected to the inverter by a single, distinct capacitive cable or a take-off therefrom. The connection topography can be radial, annular or meshed.

A first end of a conventional cable of an aircraft parked at a gate of the airport terminal is then connected to the power output at the gate and receives power from the output having a frequency of 400 Hz. A second end of the conventional cable of the aircraft is connected to an exterior aircraft socket, connected in turn inter alia to the aircraft's battery, which is therein charged by the 400 Hz power received from the power output at the gate. Optionally, a further conventional cable is connected to equipment on board the aircraft, which operates using the 400 Hz power.

### EXAMPLE 3—MOBILE INSTALLATION IN THE AVIATION INDUSTRY

Onboard an aircraft there is provided a generator unit that provides power having a frequency of 400 Hz whilst the aircraft is in flight. The aircraft additionally comprises a plurality of instruments that are each designed to operate using power supplied at a frequency of 400 Hz.

Accordingly, a plurality of instruments on board the aircraft, which includes actuators and radar devices, are each connected to the generator unit using capacitive cables, wherein each instrument is connected to the generator unit by a distinct capacitive cable or a take-off; the connection topography can be radial, annular or meshed.

In this manner, power is supplied at 400 Hz from the generator unit to each of the instruments along a capacitive cable.

### EXAMPLE 4—FIXED INSTALLATION IN THE MARITIME INDUSTRY

A high frequency power distribution network is installed at a sea port for container ships etc.

An onshore mains power supply provides power having a frequency of 50 Hz to the port via a conventional cable. Connected to the end of this conventional cable at the sea port is a single, centralised inverter. This inverter converts the 50 Hz power supplied to it to power having a frequency of 400 Hz, which is then transmitted to power outlets at each terminal. Each power outlet is connected to the inverter via a capacitive cable.

Following docking of a ship at one of the terminals, a conventional cable from the ship may be connected the power outlet at the terminal. This power is supplied along the conventional cable at a frequency of 400 Hz and is distributed, via additional conventional cables, to various systems onboard the ship that operate at this frequency.

### EXAMPLE 5—MOBILE INSTALLATION IN THE MARITIME INDUSTRY

A ship's generator provides power at a frequency of 400 Hz and supplies high frequency power directly to each of the ship's onboard systems, wherein each system is adapted to operate at a frequency of 400 Hz.

A first end of a capacitive cable is connected to the generator and a second end of the capacitive cable is connected to one of the ships onboard systems, such as the ship's lighting system.

Additional systems are connected to the generator via additional capacitive cables.

In this manner, power is transmitted between the generator and each of the onboard systems at 400 Hz and is used directly by the onboard systems at this frequency.

### EXAMPLE 6—HIGH FREQUENCY POWER TRANSMISSION VIA ELECTRICITY PYLONS

A power station, which may be any one of a coal-fired power station, a wind turbine or wind farm, a nuclear power plant, an array of solar panels, a hydroelectric dam, a geothermal power station or similar generates power having a frequency of 50 Hz and is connected to a first inverter via a first conventional cable.

The first inverter converts the frequency of the power supplied to it from 50 Hz to 200 Hz and outputs power at 200 Hz along a capacitive cable, which is connected to the inverter at its first end. The capacitive cable is several kilometres in length and is positioned above the ground between a plurality of electricity pylons. A second inverter positioned at the other end of the plurality of pylons is connected to a second end of the capacitive cable and converts the power it receives from the first inverter, via the capacitive cable, back to a frequency of 50 Hz.

The second inverter is connected by several discrete conventional cables to a plurality of plug sockets in a plurality of buildings, such as houses, each of which outputs power having a frequency of 50 Hz.

### EXAMPLE 7—MICROGRIDS

An array of solar panels installed in a field generates DC power. The array of solar panels is connected to an inverter via a conventional cable having a length of 10 m.

The inverter converts the power supplied to it to a power output of AC having a frequency of 500 Hz. The output power is then transmitted via a 500 Hz ring main, with distinct 500 Hz off-takes. A second end of each of these capacitive cables/off-takes is connected to an output device, which may be any one of a wireless phone charger, a fridge, air-conditioning compressor, a lighting element such as a light bulb or a light-emitting diode (“LED”) or similar. This output device operates at a frequency of 500 Hz.

### EXAMPLE 8—HIGH FREQUENCY POWER GENERATION AND TRANSMISSION VIA ELECTRICITY PYLONS

A power station, which may be any one of a gas-fired or coal-fired power station, a wind turbine or wind farm, a nuclear power plant, an array of solar panels, a hydroelectric dam, a geothermal power station or similar generates power having a frequency of 200 Hz.

The power station is connected by a capacitive cable, which is several kilometres in length and suspended above the ground via a network of electricity pylons, to an inverter, which converts the power supplied to it to power having a frequency of 60 Hz.

The inverter is connected via a plurality of conventional cables to a plurality of plug sockets in a plurality of buildings, wherein each plug socket outputs power at a frequency of 60 Hz.

The invention thus provides power supply and distribution networks and, specifically, a wireless electric vehicle charging system, and methods of use thereof.

1-45. (canceled)

46. A power supply system, comprising a first node, a second node, and an electrically conducting cable, wherein the first node is connected to the second node via the electrically conducting cable, wherein
the cable is for conducting alternating current at a frequency of at least 350 Hz between the first and second nodes, and
the electrically conducting cable is a capacitive cable, wherein the capacitive cable is a cable that has a capacitive coupling within its conductor/conductive elements and is represented in a circuit diagram by a capacitor.

47. A power supply and distribution network comprising the power supply system of claim 46.

48. A wireless electric vehicle charging system comprising the power supply system of claim 46.

49. The power supply system of claim 46, wherein the second node is connected to one or more electrical appliances that convert the power into heat, light and/or mechanical work, such as motors, actuators, light bulbs, heaters, instruments, machines etc that operate using power at a frequency of at least 350 Hz.

50. The power supply system of claim 46, wherein the second node is connected to a converter that reduces the frequency down to about 50 or to about 60 Hz.

51. The power supply system of claim 46, wherein the capacitive cable is of length 5 m or greater.

52. The power supply system of claim 46, wherein the current has a frequency of at least 20 KHz.

53. The power supply system of claim 46, wherein the current has a frequency of at least 80-85 kHz.

54. An airport, seaport, aircraft or ship comprising the power supply system of claim 46.

55. A method of supplying power between 2 nodes in a power supply system, comprising
providing a first node, a second node, and an electrically conducting cable, wherein the first node is connected to the second node via the electrically conducting cable, and
providing power to the first node, wherein
the power is alternating current at a frequency of at least 350 Hz, and
the electrically conducting cable is a capacitive cable, wherein the capacitive cable is a cable that has a capacitive coupling within its conductor/conductive elements and is represented in a circuit diagram by a capacitor.

56. The method of claim 55 wherein the current has a frequency of at least 20 KHz.

57. A wireless electric vehicle charging system, comprising
(a) a power supply,
(b) an inverter connected to the power supply and adapted to output power at a frequency of at least 350 Hz, and
(c) a plurality of wireless charging stations, each comprising at least one transmitter,
wherein the inverter is connected to each of the plurality of wireless charging stations using a capacitive cable, wherein the capacitive cable is a cable that has a capacitive coupling within its conductor/conductive elements and is represented in a circuit diagram by a capacitor.

58. The wireless electric vehicle charging system of claim 57, wherein the inverter is connected to at least 5 wireless charging stations.

59. The wireless electric vehicle charging system of claim 57, wherein the power output of the inverter is polyphasic and power from different phases is supplied to different wireless charging stations.

60. The wireless electric vehicle charging system of claim 57, wherein the inverter is a 3-phase inverter.

61. The wireless electric vehicle charging system of claim 57, for charging one or more stationary electric vehicles.

62. The wireless electric vehicle charging system of claim 57, for charging one or more moving electric vehicles.

63. The wireless electric vehicle charging system of claim 57, wherein the wireless electric vehicle charging system is provided as two or more sub-systems, each having:
(a) an inverter connected to a power supply and adapted to output power at a frequency of at least 350 Hz, and
(b) a plurality of wireless charging stations, each comprising at least one transmitter,
wherein the inverter is connected to each of the plurality of wireless charging stations using a capacitive cable, and wherein
the inverters of the two sub-systems are connected in parallel to the power supply,
the capacitive cable in each sub-system is connected to the capacitive cable in one of the other sub-systems, and
each sub-system acts as a backup system for one of the other sub-systems in the event that one of the inverters ceases to function.

64. The wireless electric vehicle charging system of claim 63, wherein
(a) the power output of the inverter is polyphasic, and
(b) each phase of the capacitive cable in each sub-system is connected to the same phase of the capacitive cable in the other sub-system.

65. A method of charging an electric vehicle, comprising positioning the electric vehicle in the proximity of a wireless charging station, being part of the wireless electric vehicle charging system of claim 57.
